(19) United States
(12) Patent Application Publication
(10) Pub. No.: US 2013/0046821 A1
(43) Pub. Date: Feb. 21, 2013

(54) Advanced Machine-To-Machine Communications

(71) Applicants: Seppo M. ALANARA, Oulu (FI); Jianke Fan, Espoo (FI)

(72) Inventors: Seppo M. ALANARA, Oulu (FI); Jianke Fan, Espoo (FI)

(73) Assignee: Renasas Mobile Corporation, Tokyo (JP)

(21) Appl. No.: 13/209,619

(22) Filed: Aug. 15, 2011

(51) Int. Cl. G06F 15/16

(52) U.S. Cl. 709/204

(57) ABSTRACT

There are provided measures for advanced machine-to-machine communications. Such measures may exemplarily includes conducting machine-to-machine packet transmission of a machine device residing in a connected mode by using a bearer connection with a security context, causing transition of the machine device from the connected mode to an intermediate mode, in which the machine device is neither in connected mode nor in idle mode, after completion of the machine-to-machine packet transmission, and keeping the security context of the connection for the intermediate mode, and causing transition of the machine device from the intermediate mode to the connected mode after elapse of an inactivity period of the machine-to-machine packet transmission, and conducting machine-to-machine packet transmission of the machine device residing in the connected mode by reactivating the bearer connection with the kept security context.

### FIELD OF THE INVENTION

The present invention relates to advanced machine-to-machine communications. More specifically, the present invention relates to measures (including methods, apparatuses and computer program products) for advanced machine-to-machine communications.

### BACKGROUND

In the field of mobile communication systems, including cellular communication systems, machine-based or automated communications play an increasing role in the overall traffic. This type of communications is typically referred to as machine-to-machine (M2M) communications or machine type communications (MTC).

Such machine-to-machine (M2M) communications could be seen as a form of data communication between entities that may have no human interaction. That is, such machine-to-machine (M2M) communications involve communications without (or only limited) human intervention at the originating/input side. A M2M equipment, which is hereinafter mostly referred to as machine device or M2M device, could be seen as a device that could be a fully self-contained device or a device with interfaces to attach, for example, sensors and on-site service equipment.

Such machine-to-machine (M2M) communications are different to current communication models because of involving new or different market scenarios, lower costs and effort, a potentially very large number of communicating terminals with, to a large extent, little traffic per terminal.

Such machine-to-machine (M2M) communications could be utilized in a variety of applications and use cases. For example, consumer products manufacturers (such as car manufacturers) could keep in touch with their products after they are shipped, heating and air condition, alarm systems and other applications in the home environment could be remotely maintained or controlled, and so on. Exemplary applications and use cases could involve security (e.g. access control, alarm systems), tracking and tracing (e.g. fleet management, order management, asset tracking), payment (e.g. vending machines, loyalty concepts), health (e.g. monitoring of vital signals, web access telemedicine points, remote diagnostics), remote maintenance/control (e.g. sensors, lighting), and metering (e.g. power, gas, water, industry).

Some features of such machine-to-machine (M2M) communications involve low mobility (i.e. M2M devices do not move, move infrequently, or move only within a certain region), time control (i.e. M2M devices send or receive data only at certain pre-defined periods, typically with rather long inactivity periods), packet transmission (i.e. M2M devices use packet transmission and thus require packet-switched service), small data transmissions (i.e. M2M devices frequently send or receive small amounts of data), and group-based features (i.e. M2M devices may be associated with one group).

Based on the aforementioned features, in particular those regarding time control, packet transmission, various problems in terms of system efficiency and performance arise in the context of such machine-to-machine (M2M) communications.

Such problems basically result from scenarios in which a large number of M2M devices want to transmit packet data after having been inactive for a long period. This is essentially because the M2M devices are caused to transit from connected mode to idle mode after completion of the previous packet transmission, and significant overhead of control plane (CP) signaling is required for any M2M device when transiting from the idle mode to the connected mode when the next packet transmission is falling due. All the more, as many M2M devices exhibit the same or similar characteristics relating to pre-allocated transmission times, thus initiating periodic packet transmission at the same time, corresponding (sporadic) peak in control plane signaling may be concurrently caused for a large number of M2M devices.

For example, in current LTE systems, there is a need for a relatively large number of M2M devices to switch between connected and idle mode and recreate a user plane bearer at each transition from idle to connected mode, while lots of control plane (CP) signaling is needed in user plane (UP) bearer configuration and release. While discontinued reception (DRX) could be used for facilitating power saving of terminals between packet transmissions, DRX mode is not applicable in case of longer inactivity periods, i.e. periods between transmissions exceeding 2.56 seconds. In view of typical inactivity periods for M2M communications are longer (e.g. in case of energy meters, the inactivity periods could be something from 30 minutes up to multiple days), DRX mode is thus not applicable for M2M communications.

In a current day scenario, a badly implemented retry scenario in M2M devices could result in several thousand M2M devices reestablishing a data connection every 12 seconds. M2M devices that need to send data e.g. every hour, do so at exactly every hour, resulting in peaks of several times of average load. Accordingly, other data communications applications on the packet switched network could thereby be disrupted, and M2M overload could occur. Because of the automated nature of M2M applications, they can generate very high simultaneous network loads, causing disturbances of higher priority services or even network outages. With an increasing number of M2M applications, it will become more and more difficult to prevent overload by addressing individual M2M applications service providers.

FIG. 1 shows a conventional state diagram of device states, which illustrated the aforementioned state transitions between connected mode and idle mode in case of connection establishment and release, respectively.

In the transition from RRC_IDLE mode to RRC_CONNECTED mode, RRC protection keys and UP protection keys shall typically be generated while keys for NAS protection as well as higher layer keys are assumed to be already available in the MME. These higher layer keys may have been established in the MME as a result of an AKA run, or as a result of a transfer from another MME during handover or idle mode mobility. In the transition from RRC_CONNECTED mode to RRC_IDLE mode, eNBs shall typically delete the keys they store such that state for idle mode devices only has to be maintained in MME. It is also assumed that eNB does no longer store state information about the corresponding device and deletes the current keys from its memory. In particular, on connected to idle transitions, the eNB and the terminal typically delete NH, K_{eNB}, K_{RRCenc}, K_{RRCint} and K_{UPenc} and related NCC, while the MME and the device typically keep stored K_{ASME}, K_{NASint} and K_{NASenc}.

In view thereof, there exist problems in terms of system efficiency and performance in the context of machine-to-machine communications.

Thus, there is a need to further improve machine-to-machine communications.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising conducting machine-to-machine packet transmission of a machine device residing in a connected mode by using a bearer connection with a security context, causing transition of the machine device from the connected mode to an intermediate mode, in which the machine device is neither in connected mode nor in idle mode, after completion of the machine-to-machine packet transmission, and keeping the security context of the connection for the intermediate mode, and causing transition of the machine device from the intermediate mode to the connected mode after elapse of an inactivity period of the machine-to-machine packet transmission, and conducting machine-to-machine packet transmission of the machine device residing in the connected mode by reactivating the bearer connection with the kept security context.

According to an exemplary aspect of the present invention, there is provided a method comprising performing machine-to-machine packet transmission in a connected mode by using a bearer connection with a security context, transiting from the connected mode to an intermediate mode, which is neither connected mode nor idle mode, after completion of the machine-to-machine packet transmission, and transiting from the intermediate mode to the connected mode after elapse of an inactivity period of the machine-to-machine packet transmission, and performing machine-to-machine packet transmission in the connected mode on the reactivated bearer connection with the security context of the connection before transition to the intermediate mode.

According to an exemplary aspect of the present invention, there is provided an apparatus comprising at least one interface configured for communication with at least another apparatus, at least one memory configured to store computer program code, and at least one processor, wherein the at least one processor with the computer program code is configured to cause the apparatus at least to conduct machine-to-machine packet transmission of a machine device residing in a connected mode by using a bearer connection with a security context, cause transition of the machine device from the connected mode to an intermediate mode, in which the machine device is neither in connected mode nor in idle mode, after completion of the machine-to-machine packet transmission, and keep the security context of the connection for the intermediate mode, and cause transition of the machine device from the intermediate mode to the connected mode after elapse of an inactivity period of the machine-to-machine packet transmission, and conduct machine-to-machine packet transmission of the machine device residing in the connected mode by reactivating the bearer connection with the kept security context.

According to an exemplary aspect of the present invention, there is provided an apparatus comprising at least one interface configured for communication with at least another apparatus, at least one memory configured to store computer program code, and at least one processor, wherein the at least one processor with the computer program code is configured to cause the apparatus at least to perform machine-to-machine packet transmission in a connected mode by using a bearer connection with a security context, transit the apparatus from the connected mode to an intermediate mode, which is neither connected mode nor idle mode, after completion of the machine-to-machine packet transmission, and transit the apparatus from the intermediate mode to the connected mode after elapse of an inactivity period of the machine-to-machine packet transmission, and perform machine-to-machine packet transmission in the connected mode on the reactivated bearer connection with the security context of the connection before transition to the intermediate mode.

According to an exemplary first aspect of the present invention, there is provided a computer program product comprising computer program code which, when the program is run on a computer (such as a computer of an apparatus according to any one of the aforementioned apparatus-related aspects of the present invention), is configured to execute the method according to any one of the aforementioned method-related aspects of the present invention.

According to an exemplary first aspect of the present invention, there is provided a computer-readable storage medium on which the computer program product according to the above aspect is embodied.

Further developments and features of the present invention and its aspects become more apparent from the subsequent description of exemplary embodiments.

By way of exemplary embodiments of the present invention, there is provided feasibility of advanced machine-to-machine communications. More specifically, by way of exemplary embodiments of the present invention, there are provided measures and mechanisms for advanced machine-to-machine communications.

Thus, improvement is achieved by methods, devices and computer program products enabling advanced machine-to-machine communications.

### BRIEF DESCRIPTION OF DRAWINGS

For a more complete understanding of exemplary embodiments of the present invention, reference is now made to the following description taken in connection with the accompanying drawings in which:

FIG. 1 shows a conventional state diagram of device states,

FIG. 2 shows a state diagram of device states according to exemplary embodiments of the present invention,

FIG. 3 shows a flowchart of a first example of a network-sided procedure according to exemplary embodiments of the present invention,

FIG. 4 shows a flowchart of a second example of a network-sided procedure according to exemplary embodiments of the present invention,

FIG. 5 shows a flowchart of a third example of a network-sided procedure according to exemplary embodiments of the present invention,

FIG. 6 shows a flowchart of a first example of a device-sided procedure according to exemplary embodiments of the present invention,

FIG. 7 shows a flowchart of a second example of a device-sided procedure according to exemplary embodiments of the present invention, and

FIG. 8 shows a block diagram illustrating exemplary apparatuses according to exemplary embodiments of the present invention.

### DESCRIPTION OF EXEMPLARY EMBODIMENTS

Exemplary aspects of the present invention will be described herein below. More specifically, exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following exemplary description mainly refers to specifications being used as non-limiting examples for certain exemplary network configurations and deployments. In particular, for the applicability of thus described exemplary aspects and embodiments, LTE- (including LTE-Advanced-) related cellular communication networks are used as non-limiting examples. As such, the description of exemplary aspects and embodiments given herein specifically refers to terminology which is directly related thereto. Such terminology is only used in the context of the presented non-limiting examples, and does naturally not limit the invention in any way. Rather, any other communication systems, network configurations or system deployments, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to exemplary embodiments of the present invention, in general terms, there are provided mechanisms, measures and means for advanced machine-to-machine communications (which may also be referred to as machine type communications).

In the following, exemplary embodiments of the present invention are described with reference to methods, procedures and functions, as well as with reference to structural arrangements and configurations.

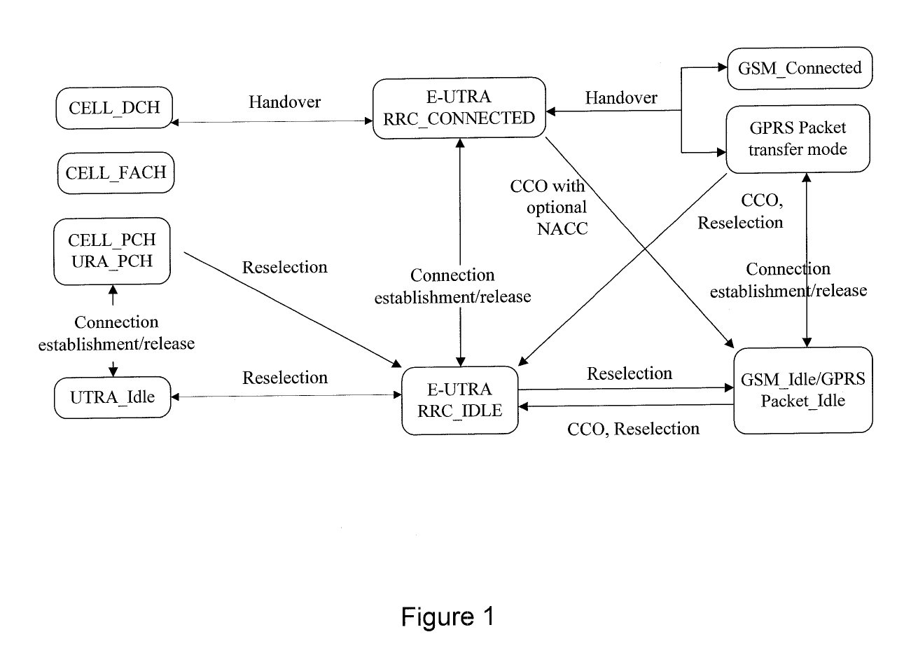

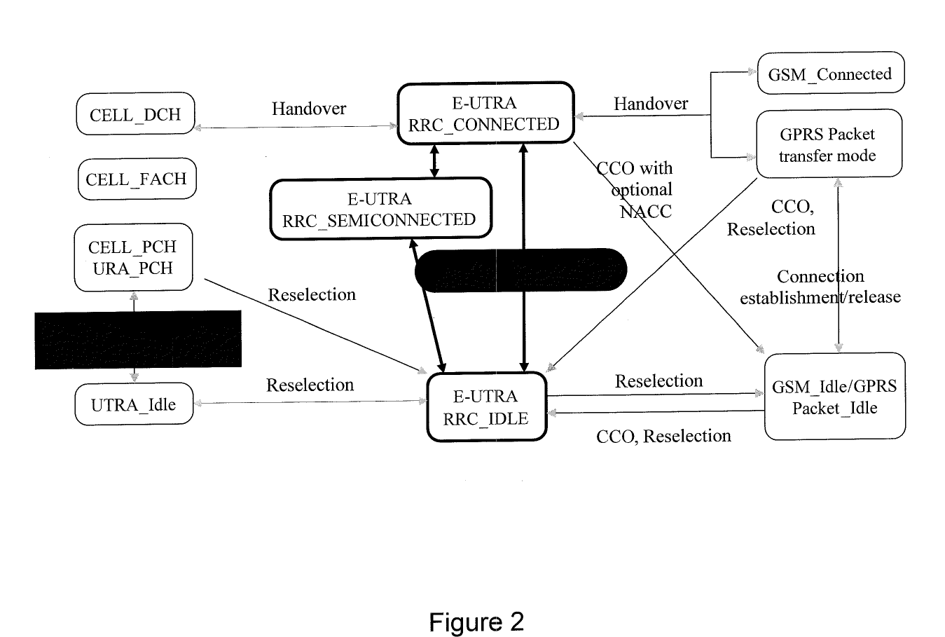

FIG. 2 shows a state diagram of device states according to exemplary embodiments of the present invention. In FIG. 2, the difference between the state diagram according to exemplary embodiments of the present invention and the conventional state diagram of FIG. 1 is highlighted by bold lines.

As shown in FIG. 2, the state diagram according to exemplary embodiments of the present invention contains a new state being exemplarily denoted as RRC_SEMICONNECTED mode (but which may e.g. also be referred to as RRC_SEMIIDLE mode). The newly introduced state according to exemplary embodiments of the present invention represents an intermediate mode or state between a connected mode (e.g. RRC_CONNECTED) and an idle mode (e.g. RRC_IDLE), i.e. a mode or state in which a device (in particular, a machine/M2M device) is neither (fully) connected nor (fully) idle.

It is noted that the aforementioned device modes or states, in particular the intermediate mode or state, relate to device modes from the perspective of the network. That is to say, such device modes or states are to be regarded in terms of network control.

Accordingly, when referring to intermediate mode, connected mode or idle mode in the subsequent description, it is mainly referred to the device mode from the perspective of the network, i.e. a network control mode or, stated in other words, a mode in terms of network control.

Such network control-related modes may differ from the actual device mode from the device's perspective. Specifically, according to exemplary embodiments of the present invention, a device may be in connected mode from its own perspective while it is in intermediate mode from the network's perspective. Thereby, a device could be beneficially and efficiently handled by way of network control when it is handled to be in intermediate mode in terms of network control (thus being able to be controlled in a simple and efficient e.g. avoiding certain control or signaling processes), although it is actually in connected mode (thus being capable of performing communications).

According to exemplary embodiments of the present invention, a machine/M2M device could be kept in the newly introduced intermediate mode which resembles both conventional connected mode and conventional idle mode. In the intermediate mode according to exemplary embodiments of the present invention, the (bearer) connection of the machine/M2M device, which is previously used in the connected mode for a preceding M2M packet transmission, is not released, and thus does not have to be (re-) established when the machine/M2M device is to initiate a subsequent M2M packet transmission. Stated in other words, while not being connected, a machine/M2M device in the intermediate mode is active (to some extent) and might be regarded as being in sort of hibernation.

In the intermediate mode according to exemplary embodiments of the present invention, a machine/M2M device may still transmit (small) data packets, which could for example be used so as to make aware the network (e.g. eNodeB) of the next M2M packet transmission time. This is feasible as the (actual physical) device mode is still the connected mode while the device mode from the perspective of the network is the intermediate mode.

Namely, according to exemplary embodiments of the present invention, such combination of a connected mode in terms of actual device operability and an intermediate mode in terms of network control enables a transmission to occur without any additional signaling being required. That is, the network knows when a next M2M packet transmission of the device is to be accomplished and may thus handle such next M2M packet transmission of the device when the device resides in the intermediate mode in terms of network control.

Therefore, exemplary embodiments of the present invention are effective for minimizing the signaling needed for M2M packet transmissions. In contrast to a case in which, since a M2M device is not in the connected mode (both in terms of actual device operability and network control), it would be required to initiate signaling to trigger the state change, exemplary embodiments of the present invention enable to avoid this signaling in case the M2M device is immobile or if mobility is so minimal that the M2M device is being served by the same eNodeB. In case a M2M device is known by the network—i.e. if the device can indicate its category as a M2M device—then the network is able to hibernate the UE RRC and IP connection immediately after packet transmission. Otherwise, in case a M2M device is not known by the network as a M2M device, then the network is able to hibernate the UE RRC and IP connection after a network timer has expired.

In view of the aforementioned feature regarding low mobility, machine/M2M devices in the intermediate mode according to exemplary embodiments of the present invention do not need to send measurement reports to the network, since this information would be mostly redundant as measurement reports would only change in case the network topology or measurement parameters are changed when the network topology is altered (e.g. when new base stations are added or removed) in the measurement range of the machine/M2M devices. Thus, the machine/M2M devices in this mode may monitor and detect system information changes and/or receive paging from a serving base station (e.g. eNB). From point of view of a core network (e.g. MME), the machine/M2M devices in this mode are in connected mode, and thus the core network (e.g. MME) does not trigger base station (e.g. eNB) paging in case packets arrive to this special class of devices. The intermediate mode according to exemplary embodiments of the present invention could be regarded as resembling Cell FACH and Cell PCH states in WCDMA.

The intermediate mode according to exemplary embodiments of the present invention may be particularly applicable for machine/M2M devices between subsequent M2M packet transmissions, i.e. during the inactivity period of packet transmissions.

According to exemplary embodiments of the present invention, the security context of the (bearer) connection of the machine/M2M device, which is previously used in the connected mode for a preceding M2M packet transmission, may be kept (i.e. saved) for being reused in a subsequent M2M packet transmission when the machine/M2M device (re-)enters the connected mode from the intermediate mode. Thereby, a (UP) security context is enabled to be reused over a long time (i.e. the inactivity period of packet transmission) without need to refresh security keys and/or other security parameters when initiate a subsequent M2M packet transmission.

Accordingly, system optimization in terms of system efficiency and performance in the context of such machine-to-machine (M2M) communications may be achieved.

According to exemplary embodiments of the present invention, a keep-alive functionality or the like may be provided. In this regard, for example the network (i.e. any network element involved) or an operator together with a service provider may carry out a keep-alive function so as to ensure that connections (e.g. IP connections) stay alive for longer periods (e.g. when a M2M device using such connection resides in the hibernated mode). Alternatively, an operator together with a service provider may ensure such staying alive of respective connections in a different manner without carrying out such keep-alive function.

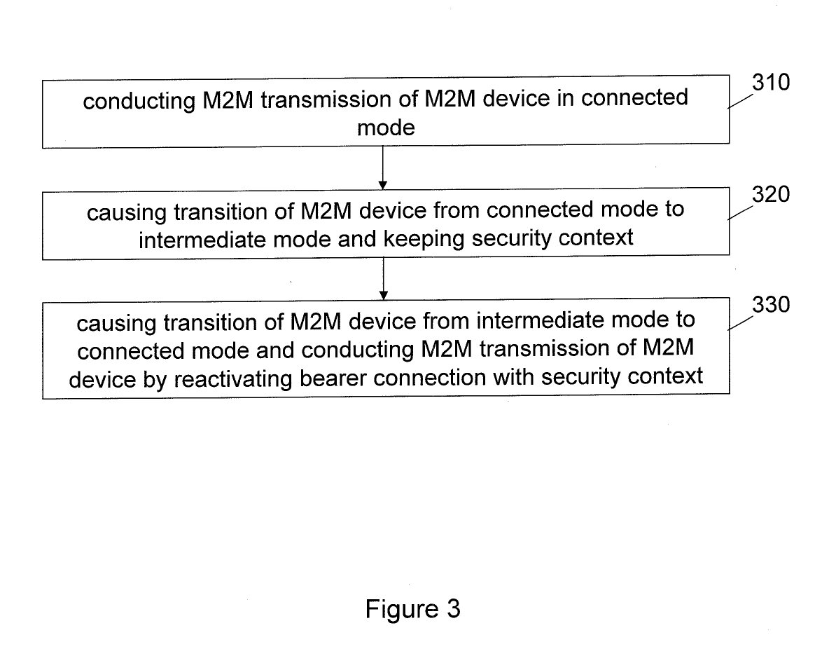

FIG. 3 shows a flowchart of a first example of a network-sided procedure according to exemplary embodiments of the present invention. The method of FIG. 3 is operable at or by a radio access network entity (such as an eNodeB) and/or a core network entity (such as a MME) of a cellular communication system (such as a LTE system or the like) in a distinct or combined manner.

As shown in FIG. 3, a method according to exemplary embodiments of the present invention may comprise an operation (310) of conducting M2M packet transmission of a M2M device residing in a connected mode by using a bearer connection with a security context, an operation (320) of causing transition of the M2M device from the connected mode to an intermediate mode, in which the M2M device is neither in connected mode nor in idle mode, after completion of the M2M packet transmission, and keeping (or, stated in other words, hibernating) the security context of the connection for the intermediate mode, and an operation (330) of causing transition of the M2M device from the intermediate mode to the connected mode after elapse of an inactivity period of the M2M packet transmission, and conducting M2M packet transmission of the M2M device residing in the connected mode by reactivating the bearer connection with the kept security context.

As mentioned above, according to exemplary embodiments of the present invention, the aforementioned modes refer to the device modes from the perspective of the network, i.e. network control modes or, stated in other words, modes in terms of network control, which may deviate from the (actual physical) device modes from the device's own perspective.

The aforementioned operation of causing a mode transition of the device may equally be considered to represent an operation of initiating, triggering, prompting, etc. such mode transition of the device.

According to exemplary embodiments of the present invention, the operation of causing a mode transition of the device, i.e. a transition timing, is handled at the network side (e.g. by eNodeB, RNC, or the like). The transition change of the device may for example be caused immediately after (completion of) the M2M packet transmission or after a (network-specific) delay time has expired after (completion of) the M2M packet transmission. In case the network is aware of the device in question being a M2M device (e.g. by way of certain indications from the device), the state change may preferably be caused immediately after (completion of) the M2M packet transmission, while elapse of a (network-specific) delay time after (completion of) the M2M packet transmission may be preferably when the network is not aware of the device in question being a M2M device.

According to exemplary embodiments of the present invention, the security context, which may preferably be a user plane security context, may be kept at a radio access network (RAN) domain and/or a core network (CN) domain. Hence, keeping the security context for the intermediate mode according to exemplary embodiments of the present invention may comprise one or both of the following operations/functions.

In the RAN domain, the security context may be kept e.g. at a base station such as an eNodeB by saving at least one of a radio network temporary identifier of the M2M device and a physical cell identifier of a cell serving the M2M device. In this regard, a radio network temporary identifier may comprise a C-RNTI parameter used in the cell serving the M2M device, and a physical cell identifier may comprise a physCellID parameter denoting the physical cell identity of the cell serving the M2M device

Further, (at least part of) a message authentication code for integrity (MAC-I) may for example be used for control plane signaling by a M2M device, such as a handover, a tracking area update, or the like. The (at least part of) the message authentication code for integrity (MAC-I) may for example comprise a shortMAC-I parameter, which may include least significant bits (e.g. the 16 least significant bits) of the MAC-I value which could be calculated either over ASN.1 encoded as per section 8 (i.e. a multiple of 8 bits) of VarShortMAC-Input or with a key K_{RRCint} and an integrity algorithm being used in the cell. By using the (at least part of) a message authentication code for integrity (MAC-I), integrity for control plane traffic may be ensured.

According to exemplary embodiments of the present invention, integrity may for example be applied for/in M2M (CP) signaling when a M2M device performs a handover, a tracking area update, or the like (in case of changing to a new cell).

In this regard, it may be utilized that the MAC-I and the shortMAC-I may be computed at the time of sending or receiving of a message based on the message content and security parameters. In view thereof, it is not necessary to store the MAC-I and/or the shortMAC-I in keeping the security context of a connection for the intermediate mode.

In the CN domain, the security context may be kept e.g. at a mobility management entity such as MME by saving a security capability parameter of the M2M device and at least one core network parameter including at least one of an encryption algorithm of the M2M device and an integrity algorithm of the M2M device. In this regard, at least one core network parameter may include one or more of parameters UEA and UIA.

According to exemplary embodiments of the present invention, keeping the (UP) security context may also comprise keeping a (UP) bearer context, wherein a PDCP sequence and/or a bearer identity (ID) may be saved, in the RAN and/or CN domain accordingly. According to exemplary embodiments of the present invention, keeping the (UP) security context may, in addition to keeping a bearer context, also comprise keeping an IP context, in the RAN and/or CN domain accordingly. Thereby, since IP packets are transmitted using the bearer (EPS bearer), such IP packets, even when transmitted by M2M devices in the intermediate mode, can reach their destination.

According to exemplary embodiments of the present invention, the security context of a single M2M device, a group of M2M devices or all M2M devices being served by a RAN entity (e.g. eNodeB) may be kept at a CN entity (e.g. MME). For example, the CN entity may keep all security contexts of active M2M devices (i.e. M2M devices in the intermediate mode) which could not be kept at the RAN entity, e.g. due to shortage of capacity.

In case one or more security contexts of active M2M devices (i.e. M2M devices in the intermediate mode) are kept at the CN entity, a signaling between the RAN entity and the CN entity (e.g. on the S1 interface) may be accomplished. In such signaling, bearer-related parameters (in particular, bearer-related parameters of security contexts) may be added to respective messages and/or in a database where the security contexts are stored at the CN entity (e.g. MME).

According to exemplary embodiments of the present invention, transition from the intermediate mode to the connected mode may be triggered from the RAN side or the device side. In case of a RAN-sided triggering, the RAN entity (eNodeB) may transmit a paging request on a paging channel for one or more M2M devices in its serving cell. In case of a device-sided triggering, the M2M device may send a corresponding notification, which may indicate elapse of a predefined timer at the device.

According to exemplary embodiments of the present invention, the kept security (and the corresponding bearer connection) may be reactivated shortly before M2M device needs to initiate the subsequent packet transmission. To this end, small data transmissions may be accomplished during the time in which the M2M device resides in the intermediate mode such that the RAN entity is aware of the next packet transmission time of the M2M device, thereby enabling a timely reactivation of the security (and the corresponding bearer connection) of the respective M2M device.

According to exemplary embodiments of the present invention, the security context, which may preferably be a user plane security context, may be kept and/or the bearer connection, which may preferably be a user plane bearer connection, may be reactivated with the kept security context by applying a radio network temporary identifier of the M2M device, which has been allocated to the M2M device before transition to the intermediate mode. In this regard, the radio network temporary identifier may comprise a C-RNTI.

Stated in other words, according to exemplary embodiments of the present invention, the security context may apply an originally allocated C-RNTI for each M2M device when the security context is reused, i.e. the bearer connection is reactivated, namely when the M2M device is transited from the intermediate mode to the connected mode. In this regard, a bearer ID of the reactivated bearer connection may be the original bearer ID. In case the same PDCP sequence number is reused, keys are to changed, which may be accomplished e.g. by way of an intra-cell handover.

According to exemplary embodiments of the present invention, keeping the security context and/or reactivating the bearer connection with the security context may also be accomplished by applying a group identifier of a group of M2M devices. Such grouping approach may for example be applied when a number of M2M devices are grouped and/or when the RAN entity doe not have available enough individual identities for all devices (including M2M devices) to be handled, i.e. all devices (including M2M devices) residing in connected and intermediate mode. Such grouping approach according to exemplary embodiments of the present invention is explained below.

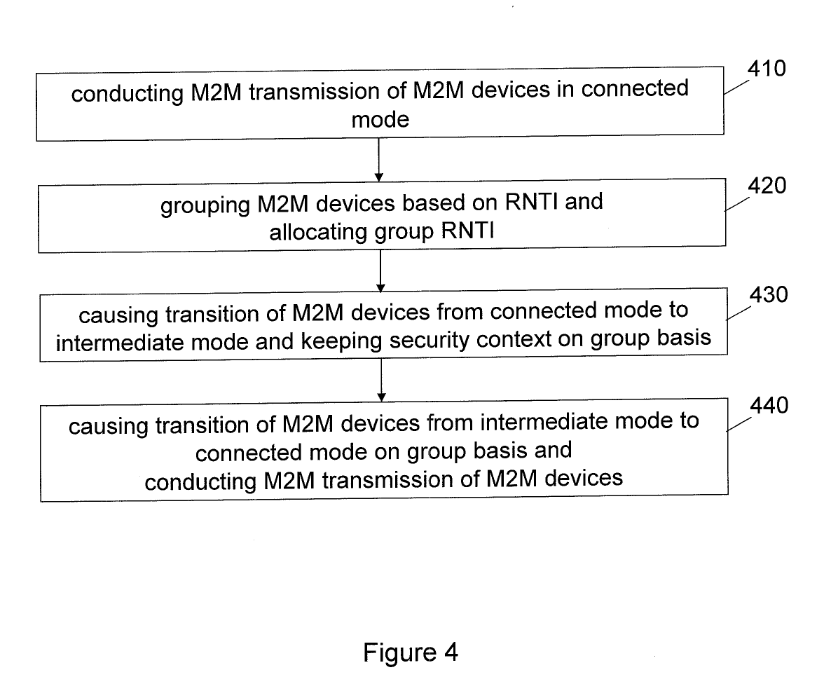

FIG. 4 shows a flowchart of a second example of a network-sided procedure according to exemplary embodiments of the present invention. Similar to FIG. 3, the method of FIG. 4 is operable at or by a radio access network entity (such as an eNodeB) and/or a core network entity (such as a MME) of a cellular communication system (such as a LTE system or the like) in a distinct or combined manner.

As shown in FIG. 4, in addition to the operations explained in connection with FIG. 3 above (i.e. operations 410, 430 and 440), a method according to exemplary embodiments of the present invention may comprise an operation (420) of grouping M2M devices having an appropriate M2M transmission periodicity on the basis of radio network temporary identifiers of the machine devices, which have been allocated to the M2M devices before transition to the intermediate mode, and allocating a group radio network temporary identifier to the group of M2M devices. Based on the grouping of M2M devices, the mode transitions may be caused on a group basis, and the bearer connection with the kept security context may be reactivated for the group of M2M devices by applying the group radio network temporary identifier, which is allocated to the group of M2M devices.

According to exemplary embodiments of the present invention, the radio network temporary identifier may comprise a C-RNTI, and the group radio network temporary identifier may comprise a group C-RNTI. The use of a group C-RNTI for a group of M2M devices provides for advantages in terms of saving C-RNTI resources, saving UL or DL grants in schedule signaling and allowing reuse of dedicated C-RNTIs e.g. for packet ciphering or the like.

When a group C-RNTI is used, it is unique at RAN (eNodeB) level and applies only as long as the M2M devices belonging to a group stay in the cell of the eNodeB. After a handover, a M2M device does not belong to its previous group any more but may be assigned to another group by the RAN entity (i.e. the eNodeB).

According to exemplary embodiments of the present invention, the keeping of security context of M2M devices belonging to a group, the causing of their transitions, as well as the reactivating of their bearer connections with security contexts may be based on the group identifier, e.g. the group C-RNTI.

M2M devices in a group may monitor the PDCCH to find uplink grants assigned for them. The monitoring may be done only at the M2M group transmission time period, wherein a transmission time period periodicity for the group may be configured at the time of creation of the group. As the M2M devices in a group may monitor a paging channel, it is possible to trigger a transmission time period also by a special group paging message using the group C-RINTI as identifier. The group paging may be implemented by the RAN entity (eNodeB) as a normal paging is from the CN entity (MME).

A common group identifier for plural M2M devices may be used, while security keys and other security parameters may be individually and uniquely generated, since different M2M devices have their own USIM or ISIM to be used for security value generation, respectively.

According to exemplary embodiments of the present invention, for conducting the M2M packet transmission of the group of M2M devices after the transition of from the intermediate mode to the connected mode (i.e. in operation 440), the M2M devices in the one or more groups are to be scheduled. In this regard, UL and DL grants may use the group C-RNTI for CRC counting, and the packets may be identified through ciphering using the original C-RNTI.

On the one hand, such scheduling of M2M devices based on a group C-RNTI may comprise scheduling the machine devices such that that at least one of uplink and downlink grants are shared between machine devices of different groups and channel access of the individual machine devices of the different groups is assigned at a predetermined order on the basis of the radio network temporary identifiers of the individual machine devices in the different groups. Namely, there could be different group devices using the same UL and DL grants but in different order of time/slot. For example, following current system specifications, in one group different devices may have different UL and DL grants by their C-RNTI assigned by the eNodeB. The eNodeB may allocate the same amount, same information of UL and DL grants to another group of devices, for example a group of devices of a second group C-RNTI. The devices of the two group C-RNTIs may be trigged in the order of different time/slot.

On the other hand, such scheduling of M2M devices based on a group C-RNTI may comprise scheduling the machine devices such that at least one of uplink and downlink grants are shared between the machine devices of one group and channel access of the individual machine devices of the one group is assigned at a predetermined order on the basis of the radio network temporary identifiers of the individual machine devices in the one group. Namely, in one group there could be devices sharing one UL and DL grant, but different devices with their C-RNTI may have the access right at the pre-determined time/slot order.

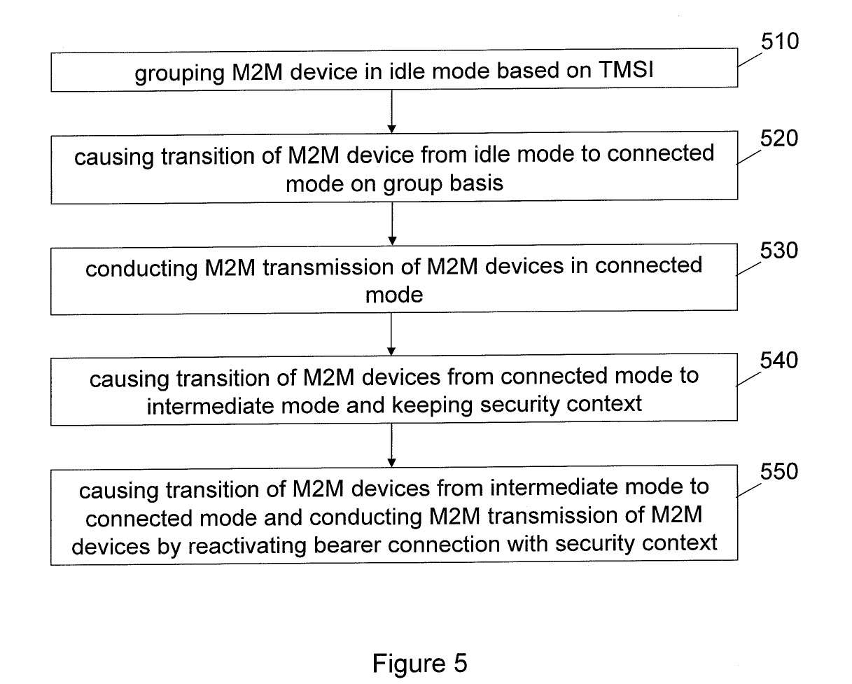

FIG. 5 shows a flowchart of a third example of a network-sided procedure according to exemplary embodiments of the present invention. Similar to FIGS. 3 and 4, the method of FIG. 5 is operable at or by a radio access network entity (such as an eNodeB) and/or a core network entity (such as a MME) of a cellular communication system (such as a LTE system or the like) in a distinct or combined manner.

As shown in FIG. 5, in addition to the operations explained in connection with FIG. 3 above (i.e. operations 530, 540 and 550), a method according to exemplary embodiments of the present invention may comprise an operation (510) of grouping M2M devices residing in an idle mode and having appropriate timing advance (TA) parameters on the basis of temporary mobile subscriber identities of the machine devices, and an operation (520) of causing transition of the group of M2M devices from the idle mode to the connected mode by paging the group of M2M devices by a radio access network entity.

According to exemplary embodiments of the present invention, the temporary mobile subscriber identity may comprise a TMSI of a respective M2M device, and the radio access network entity may comprise an eNodeB.

According to exemplary embodiments of the present invention, the procedure may be based on the TMSI of M2M devices residing in idle mode for bringing the M2M devices to connected mode before the above-described processes of hibernation may be applied on the basis of an original C-RNTI of an individual M2M device or a group C-RNTI allocated to a group of M2M devices. Accordingly, the additional operations (510 and 520 of FIG. 5) are compatible, and may thus be combined, with any one of the procedures of FIGS. 3 and 4 above. That is to say, a TMSI-based grouping for accomplishing transition from idle mode to connected mode is independent of a (potentially) subsequent C-RNTI-based grouping for accomplishing hibernation, i.e. temporary transition from connected mode to intermediate (i.e. semi-connected/idle) mode.

A TMSI-based grouping approach according to exemplary embodiments of the present invention may be based on the knowledge of the CN, e.g. the MME, about which TMSI belongs to which device. Since the CN, e.g. the MME, does not know which device belongs to, i.e. is served by, which RAN entity, e.g. eNodeB, it is to be caused that the eNodeB stores TMSI information of the served devices. Thereby, the eNodeB may be made a group paging initiator. Accordingly, the MME may instruct or order devices having same/close TA parameters to a certain eNodeB, and the eNodeB may group the devices based on their TMSI in consideration of their TA parameters. Then, the eNodeB may perform a group paging of resulting groups of devices residing in idle mode. After a slotted access of a random access procedure, the devices are transited to connected mode and obtain an original C-RNTI. Based thereon, a procedure according to any one of FIGS. 3 and 4 could be followed by the thus handled devices residing in connected mode.

Such TMSI-based grouping approach according to exemplary embodiments of the present invention is effective in that RACH load may be distributed in time and thus could help in terms of a RAN overload issue.

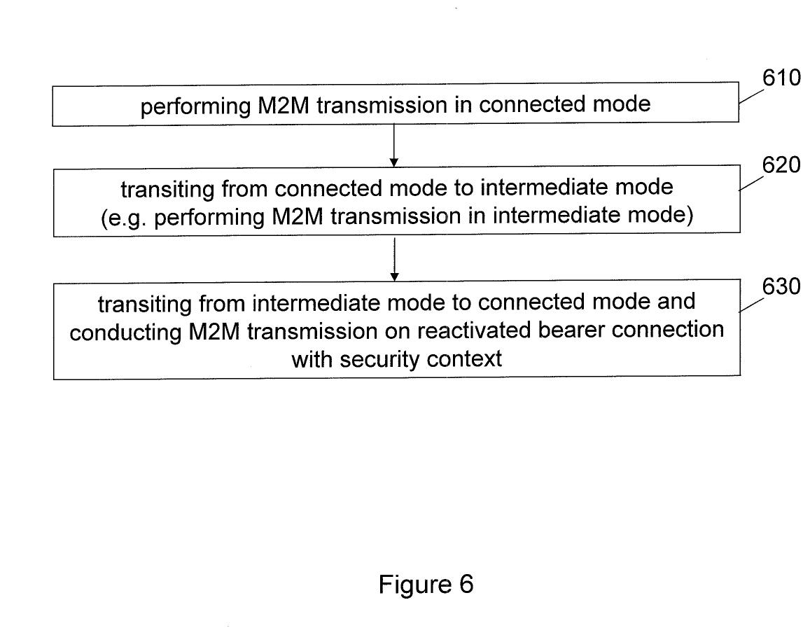

FIG. 6 shows a flowchart of a first example of a device-sided procedure according to exemplary embodiments of the present invention. The method of FIG. 6 is operable at or by a M2M device of/in a cellular communication system (such as a LTE system or the like).

As shown in FIG. 6, a method according to exemplary embodiments of the present invention may comprise an operation (610) of performing M2M packet transmission in a connected mode by using a bearer connection with a security context, an operation (620) of transiting from the connected mode to an intermediate mode, which is neither connected mode nor idle mode, after completion of the M2M packet transmission, and an operation (630) of transiting from the intermediate mode to the connected mode after elapse of an inactivity period of the M2M packet transmission, and performing M2M packet transmission in the connected mode on the reactivated bearer connection with the security context of the connection before transition to the intermediate mode.

According to exemplary embodiments of the present invention, a M2M device is operated on the basis of the state diagram according to FIG. 2.

As mentioned above, according to exemplary embodiments of the present invention, the aforementioned modes refer to the device modes from the perspective of the network, i.e. network control modes or, stated in other words, modes in terms of network control, which may deviate from the (actual physical) device modes from the device's own perspective.

As the procedure of FIG. 6 basically corresponds to the device-side equivalent of the above-explained network-sided procedure of FIG. 3, reference is made to the description thereof for details. Namely, the device-sided operations and functions are considered to be evident from the above description of the network-sided operations and functions.

According to exemplary embodiments of the present invention, a M2M device may, when residing in the intermediate mode, listen to at least one dedicated channel for monitoring system information changes and/or receiving paging, such as a forward access channel, a paging channel, or the like.

According to exemplary embodiments of the present invention, a M2M device may, when residing in the intermediate mode, perform M2M packet transmission with the security context of the connection before transition to the intermediate mode. This is indicated in operation 620 of FIG. 2. Such packet transmission in the intermediate mode may specifically comprise a small packet transmission, and may be accomplished using a bearer context and/or IP context being saved for the intermediate mode (e.g. as part of keeping the security context).

According to exemplary embodiments of the present invention, a M2M device may, in performing a M2M packet transmission, share at least one of UL and DL grants by using at least one of a bearer context, including a packet data sequence number and a bearer identity of the bearer connection, and an Internet protocol context. Thereby, the above-described scheduling of M2M devices may be utilized for an actual M2M device access.

Namely, according to exemplary embodiments of the present invention, sharing of an UL grant identified with a group C-RNTI between the M2M devices belonging to said group may be accomplished as follows.

The UL grant may be provided for one M2M device identified with the C-RNTI, may be identified with the group C-RNTI. The grant may be given for one group transport block (TB) which preferably is a multiple of resource blocks (RB). In case multiple M2M devices are sharing one UL grant, this means that the grant is divided between the M2M devices in the group. Thus, it would be most effective, if the TB size can be divided between the M2M devices so that modulus of TB size in RBs is zero, i.e. there is no remainder (of resources). Each M2M device may then use the member TB assigned to it based on its order within the group. A member TB may consist of one or more RBs, depending on how many TBs were in the original group TB. The order is for example set up when the group is created, or when the group is modified.

When each M2M device is performing the UL transmission using its assigned RBs, it may do the ciphering based on its original first dedicated C-RNTI, and ciphering keys are based on the keys acquired in the first authentication of the M2M device. So, all M2M devices may be authenticated initially using its own USIM secret information and additional parameters from the MME and HSS. Each M2M device may apply its original C-RNTI when computing the CRC to the TB. Thus, e.g. the eNB may be able to verify the original UE's identity based on both ciphering and the CRC that has been applied to the member TB.

Accordingly, for obtaining access to a channel using the shared UL grant, the M2M devices according to exemplary embodiments of the present invention, may perform ciphering using specific parameters. Such parameters as mentioned below are available in the connected mode and are made available in the intermediate mode as a result of keeping the security context.

In such ciphering, two parameters typically denoted as COUNT and BEARER (see e.g. 3GPP TS 36.323) may be utilized e.g. when using an EPS encryption algorithm (EEA). Hence, ciphering according to exemplary embodiments of the present invention may be accomplished based on the principles set out in 3GPP TS 36.323. The parameter COUNT represents a packet data sequence number, and may e.g. be a PDCP sequence number. As ciphering must always use different input parameters and the same PDCP sequence number can only be used once for one ciphering key, it is proposed by exemplary embodiments of the present invention that such packet data sequence number is kept/saved (for the intermediate mode). The parameter BEARER represents bearer identity of the bearer connection, and may e.g. be a DRB-identity, as mentioned in 3GPP TS 36.331. Such bearer identity is also proposed to be kept/saved (for the intermediate mode) by exemplary embodiments of the present invention. The parameters COUNT and BEARER may be regarded to constitute a bearer context, as mentioned above.

When all available packet data sequence numbers have been used, a new key needs to be generated. In that case, a new key needs may be generated e.g. by way of an “intra-cell handover” of the respective M2M device/devices. Such “intra-call handover” is not a real (physical) handover but one that is executed to replenish the ciphering key by making available new packet data sequence numbers.

The aforementioned parameters COUNT and BEARER may also be utilized for integrity purposes. Hence, integrity protection according to exemplary embodiments of the present invention may be accomplished based on the principles set out in 3GPP TS 36.331. Namely, in terms of ensuring integrity, the MAC-I and the shortMAC-I may be computed based on these parameters both at the sender and receiver of a message e.g. when using an EPS integrity algorithm (EIA). According to exemplary embodiments of the present invention, this is especially useful for messages to be transmitted for/in M2M (CP) signaling when a M2M device performs a handover, a tracking area update, or the like (in case of changing to a new cell).

According to exemplary embodiments of the present invention, a M2M device may verify its serving cell or base station (e.g. eNodeB) upon transiting from the intermediate mode to the connected mode. Namely, when an eNodeB is able to allocate a dedicate C-RNTI or the like to M2M devices and keeping them in intermediate mode where the M2M devices are dormant for long periods (thus saving power) and then wake up to access the eNodeB in connected mode, each M2M device may verify whether it is still connected to the same eNodeB and the reselection rules still allow it to keep using the same cell as before the dormant period in the intermediate mode. If not, the M2M device may perform an inter- or intra-cell handover, respectively.

According to exemplary embodiments of the present invention, a M2M device may trigger a subsequent transmission time period for a following M2M packet transmission when residing in intermediate mode. Such triggering may be based on a time basis, i.e. by elapse of a timer being configured with a predefined transmission time or transmission time period periodicity, and/or on demand by the network (e.g. eNodeB and/or MME), i.e. by receipt of a corresponding instruction, e.g. a paging request.

According to exemplary embodiments of the present invention, a M2M device may be subject to a grouping as explained in connection with the procedure of FIG. 4 above.

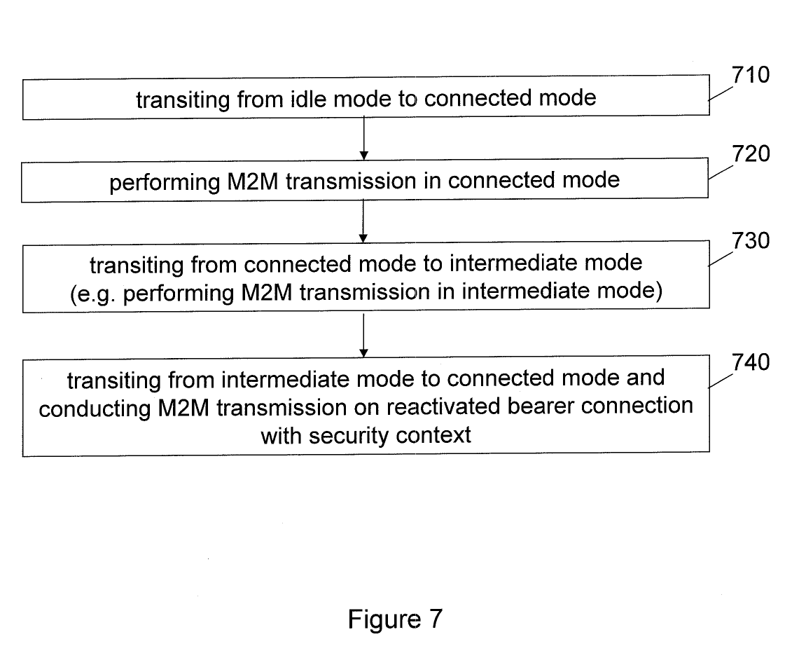

FIG. 7 shows a flowchart of a second example of a device-sided procedure according to exemplary embodiments of the present invention. Similar to FIG. 6, the method of FIG. 7 is operable at or by a M2M device of/in a cellular communication system (such as a LTE system or the like).

As shown in FIG. 7, in addition to the operations explained in connection with FIG. 6 above (i.e. operations 720, 730 and 740), a method according to exemplary embodiments of the present invention may comprise an operation (710) of transiting from an idle mode to the connected mode based on paging by a radio access network entity, such as an eNodeB.

As the procedure of FIG. 7 basically corresponds to the device-side equivalent of the above-explained network-sided procedure of FIG. 5, reference is made to the description thereof for details. Namely, the device-sided operations and functions are considered to be evident from the above description of the network-sided operations and functions.

As indicated above, even in connection with the procedure of FIG. 7, a M2M device may be subject to a grouping as explained in connection with the procedure of FIG. 4 above.

In the following, an exemplary process flow in accordance with exemplary embodiments of the present invention is described as a conceivable use case by way of example only.
1. One or more M2M devices get network access e.g. by using an existing handshaking procedure when they are powered on.
2. The network (e.g. eNodeB) recognizes the type of the M2M devices and keeps the C-RNTI of the individual M2M devices.
3. The network (e.g. eNodeB and/or MME) saves or keeps the security context and potentially the bearer context including PDCP sequence number and bearer ID in order to keep using the same security keys/parameters.
4. Based on the saved C-RNTI and the M2M device uplink packet transmission periodicity, the network (e.g. eNodeB and/or MME) groups the M2M devices which are configured to transmit data packets at pre-allocated times.
5. The network (e.g. eNodeB and/or MME) transits the M2M devices from RRC connected mode to RRC semi-connected mode.
6. When the configured or paged transmission period is due, the network (e.g. eNodeB and/or MME) transits the M2M devices from RRC semi-connected mode to RRC connected mode.
7. The M2M devices use resource grants successively based on the order that is decided when the group is initially configured. For example, a group C-RNTI contains individual C-RNTIs and corresponding UL resource allocation at the subframe of a frame or frames in successive order.
8. After M2M devices of one group have performed their packet transmission, the network (e.g. eNodeB and/or MME) checks, if there is a handover or cell re-selection case. If so, then the network (e.g. eNodeB and/or MME) re-groups the M2M devices and returns to step 1 above. If not, the network (e.g. eNodeB and/or MME) transits the M2M devices back to RRC semi-connected mode and returns to step 4 above. The M2M devices stay in semi-connected mode over a long time period but are not required to do measurements as much as normally.

In view thereof, it ma be noted that
a dedicated C-RNTI may be used for a basic configuration of M2M devices, and an optional group C-RNTI may enable group-type packet transmission where shared channel resource grants are provided using group C-RNTI and ciphering uses dedicated C-RNTI;
M2M devices may use resource grants successively based on the order that is decided based on their C-RNTI and/or when a group is initially configured;
a M2M device security context may be kept periodically in the eNodeB, while a security context based on authentication may be kept in a serving MME and/or home HSS;
if a security context is not kept all the time in the eNodeB when a M2M device resides in periodical connected mode, it may be retrieved to the eNodeB before the M2M device starts to upload data to a M2M application server.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

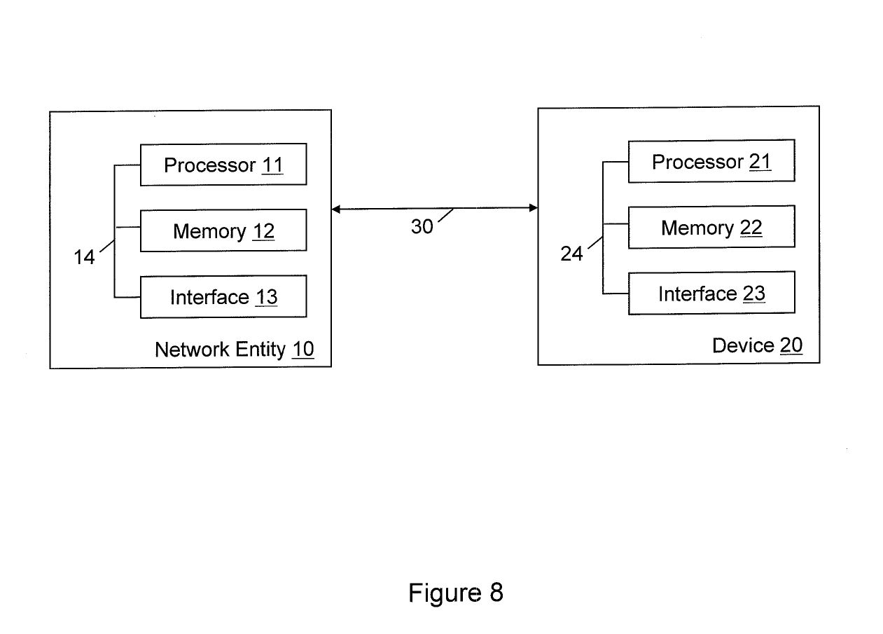

Respective exemplary embodiments of the present invention are described below referring to FIG. 8, while for the sake of brevity reference is made to the detailed description of respective corresponding methods and operations according to FIGS. 2 to 7.

In FIG. 8 below, which is noted to represent a simplified block diagram, the solid line blocks are basically configured to perform respective operations as described above. The entirety of solid line blocks are basically configured to perform the methods and operations as described above, respectively. With respect to FIG. 8, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 8, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 8 shows a block diagram illustrating exemplary apparatuses according to exemplary embodiments of the present invention.

In view of the above, the thus described apparatuses 10 and 20 are suitable for use in practicing the exemplary embodiments of the present invention, as described herein. The thus described apparatus 10 may represent a (part of a) network entity, i.e. a RAN entity (e.g. eNodeB) and/or CN entity (e.g. MME) or the like, as described above, and may be configured to perform a procedure and/or exhibit a functionality as described in conjunction with any one of FIGS. 3 to 5, and to control a state of a M2M device according to the state diagram of FIG. 2. The thus described apparatus 20 may represent a (part of a) M2M device, as described above, and may be configured to perform a procedure and/or exhibit a functionality as described in conjunction with any one of FIGS. 6 and 7, and to adopt a state according to the state diagram of FIG. 2.

As shown in FIG. 8, according to exemplary embodiments of the present invention, a network entity 10 comprises a processor 11, a memory 12, and an interface 13, which are connected by a bus 14 or the like, and a device 20 comprises a processor 21, a memory 22, and an interface 23, which are connected by a bus 24 or the like. The device 20 may be connected with the network entity 10 through a link or connection 30.

The memories 12 and 22 may store respective programs assumed to include program instructions that, when executed by the associated processors 11 and 21, enable the respective electronic device or apparatus to operate in accordance with the exemplary embodiments of the present invention. For example, the memory 12 of the network entity 10 may keep the security context or contexts of one or more devices, i.e. save respective parameters. The processors 11 and 21 and/or the interfaces 13 and 23 may also include a modem or the like to facilitate communication over the (hardwire or wireless) link 30, respectively. The interfaces 13 and 23 may include a suitable transceiver coupled to one or more antennas or communication means for (hardwire or wireless) communications with the linked or connected device(s), respectively. The interfaces 13 and 23 are generally configured to communicate with another apparatus, i.e. the interface thereof.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus perform at least the thus mentioned function. Also, such function is to be construed to be equivalently implementable by specifically configured means for performing the respective function (i.e. the expression “processor configured to xxx” is equivalent to an expression such as “means for xxx-ing”).

According to exemplary embodiments of the present invention, the interface 13 is generally configured for communication with at least another apparatus. The processor 11 is configured to conduct M2M packet transmission of device 20 residing in a connected mode by using a bearer connection with a security context, to cause transition of device 20 from the connected mode to an intermediate mode, in which the device is neither in connected mode nor in idle mode, after completion of the M2M packet transmission, and keep the security context of the connection for the intermediate mode, and to cause transition of device 20 from the intermediate mode to the connected mode after elapse of an inactivity period of the M2M packet transmission, and conduct M2M packet transmission of the machine device residing in the connected mode by reactivating the bearer connection with the kept security context.

According to exemplary embodiments of the present invention, the processor 11 may be configured to perform any one of the aforementioned operations and functions explained in connection with FIGS. 3 to 5. This includes for example any one of the aforementioned operations and functions relating to
reactivating the bearer connection with the kept security context by applying a radio network temporary identifier of the device,
grouping devices on the basis of radio network temporary identifiers of the machine devices, and reactivating the bearer connection with the kept security context for the group of devices by applying an allocated group radio network temporary identifier,
scheduling the devices
saving, when the network entity comprises a radio access network entity, at least one of a radio network temporary identifier of the device and a physical cell identifier of a cell serving the device,
saving, when the network entity comprises a core network entity, security capability parameter of the device and at least one core network parameter including at least one of an encryption algorithm of the device and an integrity algorithm of the device,
saving, when the network entity comprises a core network entity and/or a radio access network entity, at least one of a bearer context, including a packet data sequence number and a bearer identity of the bearer connection, and an internet protocol context,
grouping devices residing in an idle mode on the basis of temporary mobile subscriber identities of the machine devices, and causing transition of the group of devices from the idle mode to the connected mode.

According to exemplary embodiments of the present invention, the processor 11 may be configured to cause a mode transition of the device immediately after (completion of) the M2M packet transmission (which may be specifically effective when the apparatus on the network side is aware of the device in question being a M2M device) or after a (network-specific) delay time has expired after (completion of) the M2M packet transmission (which may be specifically effective when the apparatus on the network side is not aware of the device in question being a M2M device).

According to exemplary embodiments of the present invention, the interface 23 is generally configured for communication with at least another apparatus. The processor 21 is configured to perform M2M packet transmission in a connected mode by using a bearer connection with a security context, to transit the device from the connected mode to an intermediate mode, which is neither connected mode nor idle mode, after completion of the M2M packet transmission, and to transit the device from the intermediate mode to the connected mode after elapse of an inactivity period of the M2M packet transmission, and perform M2M packet transmission in the connected mode on the reactivated bearer connection with the security context of the connection before transition to the intermediate mode.

According to exemplary embodiments of the present invention, the processor 21 may be configured to perform any one of the aforementioned operations and functions explained in connection with FIGS. 6 and 7. This includes for example any one of the aforementioned operations and functions relating to
performing M2M packet transmission in the intermediate mode with the security context being kept,
sharing at least one of uplink and downlink grants by using at least one of a bearer context, including a packet data sequence number and a bearer identity of the bearer connection, and an internet protocol context,
transiting the device from an idle mode to the connected mode,
listening to at least one dedicated channel for monitoring system information changes and/or receiving paging.

According to exemplarily embodiments of the present invention, the processor 11 or 21, the memory 12 or 22 and the interface 13 or 23 can be implemented as individual modules, chipsets or the like, or one or more of them can be implemented as a common module, chipset or the like, respectively.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, the present invention and/or exemplary embodiments thereof provide measures for advanced machine-to-machine communications. Such measures may exemplarily comprise conducting machine-to-machine packet transmission of a machine device residing in a connected mode by using a bearer connection with a security context, causing transition of the machine device from the connected mode to an intermediate mode, in which the machine device is neither in connected mode nor in idle mode, after completion of the machine-to-machine packet transmission, and keeping the security context of the connection for the intermediate mode, and causing transition of the machine device from the intermediate mode to the connected mode after elapse of an inactivity period of the machine-to-machine packet transmission, and conducting machine-to-machine packet transmission of the machine device residing in the connected mode by reactivating the bearer connection with the kept security context.

Accordingly, the present invention and/or exemplary embodiments thereof may provide for advantages in terms of a reduction of signaling, in particular periodic high control plane signaling. Namely, there is less RRC signaling when a RRC connection and radio bearer are in a standby state, i.e. the intermediate state, for long periods. This is especially effective when there is a large number of devices which need to upload collected data periodically, such as M2M devices, as for small data packets there is a significant overhead, if RRC connection and radio bearers need to be individually established for each packet transmission.

Even though the present invention and/or exemplary embodiments are described above with reference to the examples according to the accompanying drawings, it is to be understood that they are not restricted thereto. Rather, it is apparent to those skilled in the art that the present invention can be modified in many ways without departing from the scope of the inventive idea as disclosed herein.

### List of Acronyms and Abbreviations

### AKA Authentication and Key Agreement

### CN Core Network

### CP Control Plane

### CRC Cyclic Redundancy Check

### C-RNTI Cell Radio Network Temporary Identifier

### DL Downlink

### DRB Data Radio Bearer

DRX discontinued reception

### EIA EPS Integrity Algorithm

### EEA EPS Encryption Algorithm

eNB evolved Node B (E-UTRAN base station)

### EPS Evolved Packet System

### E-UTRAN Evolved Universal Terrestrial Radio Access Network

### FACH Forward Access Channel

### HO Handover

### HSS Home Subscriber System

### IP Internet Protocol

### ISIM IP Multimedia Services Identity Module

### LTE Long Term Evolution

### M2M Machine-to-Machine

### MME Mobility Management Entity

### MTC Machine Type Communications

### NAS Non-Access Stratum

### PCH Paging Channel

### PDCCH Physical Downlink Control Channel

### PDCP Packet Data Convergence Protocol

### RACH Random Access Channel

### RAN Radio Access Network

### RB Resource Block

### RNTI Radio Network Temporary Identifier

### RRC Radio Resource Control

### TA Timing Advance

### TB Transport Block

### TMSI Temporary Mobile Station Identifier

### UE User Equipment

### UL Uplink

### UP User Plane

### USIM Universal Subscriber Identity Module

WCDMA Wideband Code Division Multiple Access

What is claimed is:

1. A method comprising
conducting machine-to-machine packet transmission of a machine device residing in a connected mode by using a bearer connection with a security context,
causing transition of the machine device from the connected mode to an intermediate mode, in which the machine device is neither in connected mode nor in idle mode, after completion of the machine-to-machine packet transmission, and keeping the security context of the connection for the intermediate mode, and
causing transition of the machine device from the intermediate mode to the connected mode after elapse of an inactivity period of the machine-to-machine packet transmission, and conducting machine-to-machine packet transmission of the machine device residing in the connected mode by reactivating the bearer connection with the kept security context.

2. The method according to claim 1, wherein
the bearer connection with the kept security context is reactivated for the machine device by applying a radio network temporary identifier of the machine device, which has been allocated to the machine device before transition to the intermediate mode.

3. The method according to claim 1, further comprising
grouping machine devices having an appropriate machine-to-machine packet transmission periodicity on the basis of radio network temporary identifiers of the machine devices, which have been allocated to the machine devices before transition to the intermediate mode, and allocating a group radio network temporary identifier to the group of machine devices, wherein
the mode transitions are caused on a group basis, and
the bearer connection with the kept security context is reactivated for the group of machine devices by applying the group radio network temporary identifier, which is allocated to the group of machine devices.

4. The method according to claim 3, wherein conducting the machine-to-machine packet transmission of the group of machine devices after the transition of from the intermediate mode to the connected mode comprises
scheduling the machine devices such that that at least one of uplink and downlink grants are shared between machine devices of different groups and channel access of the individual machine devices of the different groups is assigned at a predetermined order on the basis of the radio network temporary identifiers of the individual machine devices in the different groups, or
scheduling the machine devices such that at least one of uplink and downlink grants are shared between the machine devices of one group and channel access of the individual machine devices of the one group is assigned at a predetermined order on the basis of the radio network temporary identifiers of the individual machine devices in the one group.

5. The method according to claim 1, wherein keeping the security context of the connection for the intermediate mode comprises
saving, at a radio access network entity, at least one of a radio network temporary identifier of the machine device and a physical cell identifier of a cell serving the machine device, and/or
saving, at a core network entity, security capability parameter of the machine device and at least one core network parameter including at least one of an encryption algorithm of the machine device and an integrity algorithm of the machine device, and/or
saving, at a core network entity and/or a radio access network entity, at least one of a bearer context, including a packet data sequence number and a bearer identity of the bearer connection, and an internet protocol context.

6. The method according to claim 1, further comprising
grouping machine devices residing in an idle mode and having appropriate timing advance parameters on the basis of temporary mobile subscriber identities of the machine devices, and
causing transition of the group of machine devices from the idle mode to the connected mode by paging the group of machine devices by a radio access network entity.

7. The method according to claim 1, wherein at least one of the following applies:
the security context is a user plane security context,
the bearer connection is a user plane bearer connection,
in the intermediate mode, the machine device is enabled to listen to at least one dedicated channel for monitoring system information changes and/or receiving paging,
the transition from the intermediate mode to the connected mode is triggered by a paging request by a radio access network entity or a time trigger by the machine device,
the connected, idle and intermediate modes are modes of radio resource control, and
the method is operable at or by a base station and/or a mobility management entity of a cellular communication system.

8. A method comprising
performing machine-to-machine packet transmission in a connected mode by using a bearer connection with a security context,
transiting from the connected mode to an intermediate mode, which is neither connected mode nor idle mode, after completion of the machine-to-machine packet transmission, and
transiting from the intermediate mode to the connected mode after elapse of an inactivity period of the machine-to-machine packet transmission, and performing machine-to-machine packet transmission in the connected mode on the reactivated bearer connection with the security context of the connection before transition to the intermediate mode.

9. The method according to claim 8, comprising:
performing machine-to-machine packet transmission in the intermediate mode with the security context of the connection before transition to the intermediate mode.

10. The method according to claim 8, wherein performing machine-to-machine packet transmission comprises:
sharing at least one of uplink and downlink grants by using at least one of a bearer context, including a packet data sequence number and a bearer identity of the bearer connection, and an internet protocol context.

11. The method according to claim 8, wherein at least one of the following applies:
the method further comprises transiting from an idle mode to the connected mode based on paging by a radio access network entity,
the security context is a user plane security context,
the bearer connection is a user plane bearer connection,
in the intermediate mode, the method comprises listening to at least one dedicated channel for monitoring system information changes and/or receiving paging,
the transition from the intermediate mode to the connected mode is triggered by a paging request by a radio access network entity or a time trigger by a machine device,
the connected, idle and intermediate modes are modes of radio resource control, and
the method is operable at or by a machine device of a cellular communication system.

12. An apparatus comprising
at least one interface configured for communication with at least another apparatus,
at least one memory configured to store computer program code, and
at least one processor, wherein
the at least one processor with the computer program code is configured to cause the apparatus at least to
conduct machine-to-machine packet transmission of a machine device residing in a connected mode by using a bearer connection with a security context,
cause transition of the machine device from the connected mode to an intermediate mode, in which the machine device is neither in connected mode nor in idle mode, after completion of the machine-to-machine packet transmission, and keep the security context of the connection for the intermediate mode, and
cause transition of the machine device from the intermediate mode to the connected mode after elapse of an inactivity period of the machine-to-machine packet transmission, and conduct machine-to-machine packet transmission of the machine device residing in the connected mode by reactivating the bearer connection with the kept security context.

13. The apparatus according to claim 12, wherein
the at least one processor is configured to cause the apparatus to reactivate the bearer connection with the kept security context for the machine device by applying a radio network temporary identifier of the machine device, which has been allocated to the machine device before transition to the intermediate mode.

14. The apparatus according to claim 12, wherein the at least one processor is configured to cause the apparatus to
group machine devices having an appropriate machine-to-machine packet transmission periodicity on the basis of radio network temporary identifiers of the machine devices, which have been allocated to the machine devices before transition to the intermediate mode, and allocate a group radio network temporary identifier to the group of machine devices, wherein
cause the mode transitions on a group basis, and
reactivate the bearer connection with the kept security context for the group of machine devices by applying the group radio network temporary identifier, which is allocated to the group of machine devices.

15. The apparatus according to claim 14, wherein the at least one processor, for conducting the machine-to-machine packet transmission of the group of machine devices after the transition of from the intermediate mode to the connected mode, is configured to cause the apparatus to
schedule the machine devices such that that at least one of uplink and downlink grants are shared between machine devices of different groups and channel access of the individual machine devices of the different groups is assigned at a predetermined order on the basis of the radio network temporary identifiers of the individual machine devices in the different groups, or
schedule the machine devices such that at least one of uplink and downlink grants are shared between the machine devices of one group and channel access of the individual machine devices of the one group is assigned at a predetermined order on the basis of the radio network temporary identifiers of the individual machine devices in the one group.

16. The apparatus according to claim 12, wherein the at least one processor, for keeping the security context of the connection for the intermediate mode, is configured to cause the apparatus to
save, at a radio access network entity, at least one of a radio network temporary identifier of the machine device and a physical cell identifier of a cell serving the machine device, and/or
save, at a core network entity, security capability parameter of the machine device and at least one core network parameter including at least one of an encryption algorithm of the machine device and an integrity algorithm of the machine device, and/or
save, at a core network entity and/or a radio access network entity, at least one of a bearer context, including a packet data sequence number and a bearer identity of the bearer connection, and an internet protocol context.

17. The apparatus according to claim 12, wherein the at least one processor is configured to cause the apparatus to
group machine devices residing in an idle mode and having appropriate timing advance parameters on the basis of temporary mobile subscriber identities of the machine devices, and
cause transition of the group of machine devices from the idle mode to the connected mode by paging the group of machine devices by a radio access network entity.

18. The apparatus according to claim 12, wherein at least one of the following applies:
the security context is a user plane security context,
the bearer connection is a user plane bearer connection,
in the intermediate mode, the machine device is enabled to listen to at least one dedicated channel for monitoring system information changes and/or receiving paging,
the transition from the intermediate mode to the connected mode is triggered by a paging request by a radio access network entity or a time trigger by the machine device,
the connected, idle and intermediate modes are modes of radio resource control, and
the apparatus is operable as or at a base station and/or a mobility management entity of a cellular communication system.

19. An apparatus comprising
at least one interface configured for communication with at least another apparatus,
at least one memory configured to store computer program code, and
at least one processor, wherein
the at least one processor with the computer program code is configured to cause the apparatus at least to
perform machine-to-machine packet transmission in a connected mode by using a bearer connection with a security context,
transit the apparatus from the connected mode to an intermediate mode, which is neither connected mode nor idle mode, after completion of the machine-to-machine packet transmission, and
transit the apparatus from the intermediate mode to the connected mode after elapse of an inactivity period of the machine-to-machine packet transmission, and perform machine-to-machine packet transmission in the connected mode on the reactivated bearer connection with the security context of the connection before transition to the intermediate mode.

20. The apparatus according to claim 19, wherein the at least one processor is configured to cause the apparatus to perform machine-to-machine packet transmission in the intermediate mode with the security context of the connection before transition to the intermediate mode.

21. The apparatus according to claim 19, wherein the at least one processor, in performing machine-to-machine packet transmission, is configured to cause the apparatus to share at least one of uplink and downlink grants by using at least one of a bearer context, including a packet data sequence number and a bearer identity of the bearer connection, and an internet protocol context.

22. The apparatus according to claim 19, wherein at least one of the following applies:
the at least one processor is further configured to transit the apparatus from an idle mode to the connected mode based on paging by a radio access network entity,
the security context is a user plane security context,
the bearer connection is a user plane bearer connection,
in the intermediate mode, the processor is configured to listen to at least one dedicated channel for monitoring system information changes and/or receiving paging,
the transition from the intermediate mode to the connected mode is triggered by a paging request by a radio access network entity or a time trigger by a machine device,
the connected, idle and intermediate modes are modes of radio resource control, and
the apparatus is operable as or at a machine device of a cellular communication system.

23. A computer program product comprising computer program code which, when the program is run on a computer, is configured to execute the method according to claim 1.

24. The computer program product according to claim 23, embodied as a computer-readable storage medium.
